(19) United States
(12) Patent Application Publication
(10) Pub. No.: US 2023/0376920 A1
(43) Pub. Date: Nov. 23, 2023

(54) INTERACTIVE ONLINE ENTERTAINMENT SYSTEM AND METHOD

(71) Applicant: HYTTO PTE. LTD, Singapore (SG)

(72) Inventors: Dan Liu, Guangzhou (CN); Jilin Qiu, Guangzhou (CN)

(73) Assignee: HYTTO PTE. LTD, Singapore (SG)

(21) Appl. No.: 17/748,294

(22) Filed: May 19, 2022

(51) Int. Cl. G06Q 20/12; H04L 65/1083; H04L 65/611; A61H 19/00; H04L 67/025

(52) U.S. Cl. CPC G06Q 20/127; H04L 65/1086; H04L 65/611; A61H 19/30; H04L 67/025; G06Q 50/10

(57) ABSTRACT

Embodiments of the present application pertain to a method, a system and an application program providing online interactive entertainment for adults. The system includes a computing device which runs the application program. The computing device broadcasts a live stream session to terminal devices via a communication network. The computing device receives one or more tokens from a user of a terminal device during the broadcast. The tokens are rewards to a host of the live stream session. If an amount of tokens received from the terminal device is greater than or equal to a reward parameter, the computing device establishes a control connection between the computing device and the terminal device. The computing device instructs, through the control connection, an electronic device to perform one or more actions. The electronic device is an adult toy connected with the terminal device.

### TECHNICAL FIELD

The present application generally relates to communication systems. Particularly, embodiments of the present application are directed to hardware and software technologies for online interactive entertainment with adult contents.

### BACKGROUND

With development of Internet technologies, people are able to connect and interact instantly via social networking programs such as online chatting and live streaming. Forms of live stream include audio, video, text, virtual reality (VR) display, etc., collectively referred to as live stream hereinafter. These programs allow two or more individuals, usually located at different locations, to communicate in real-time. In recent years, live streaming is gaining more and more popularity. Live streaming technology enables a person to watch, create and share videos in real time. A live streaming session is typically hosted by a presenter, an organizer, a performer or the like (collectively referred to as a host hereinafter) in a live streaming studio or similar environment, and viewers of the live streaming session may interact with the host via a form of live conversation such as chatrooms. The host can also receive financial rewards from the viewers. For example, the viewers can tip the host in virtual coins (also known as tokens), which can be converted into real currency, or exchanged for goods or services.

Some live streaming applications can provide entertainment for adults (individuals whose ages are above certain limit as defined by applicable laws and regulations) wherever as permitted by law. In this regard, existing adult live streaming generally functions similarly to conventional live streaming, with exception of explicit contents. One current challenge for adult live streaming is to provide the right kinds of interactivity and real world features, so that a large number and wide range of adult users would be attracted by the more enjoyable experiences.

### SUMMARY

The following provides a brief summary of the disclosure in order to provide a basic understanding of some aspects of the present application. This summary is not an extensive overview of the present application. Its purpose is to disclose some concepts of the present application in a simplified manner as a prelude to the more detailed description that is presented later.

In a first aspect, a method for providing online interactive entertainment for adults is provided by embodiments of the present application. A computing device broadcasts a live stream to a plurality of terminal devices via a communication network. The computing device receives an indication of one or more tokens from a user of a terminal device during the broadcast of the live stream. If an amount of tokens received from the terminal device is greater than or equal to a reward parameter, the computing device establishes a control connection between the computing device and the terminal device. The computing device instructs, through the control connection, an electronic device to perform one or more actions. The electronic device is an adult toy connected with the terminal device.

In a second aspect, an online entertainment system for adults is provided by embodiments of the present application. The system includes a computing device, a terminal device connected with the computing device via a communication network, and an electronic device connected with the terminal device. The electronic device is an adult toy controlled by a user of the terminal device. The computing device includes a processor, a memory for storing an application program, and a transceiver for communicating with the terminal device. By executing the application program, the computing device is enabled to control the electronic device remotely. The computing device broadcasts an audio and video live stream to a plurality of terminal devices via the communication network. The computing device receives an indication of one or more tokens from a user of the terminal device during the broadcast of the live stream. If an amount of tokens received from the terminal device is greater than or equal to a reward parameter, the computing device establishes a control connection between the computing device and the terminal device. The computing device instructs, through the control connection, the electronic device to perform one or more actions.

In a third aspect, an application program is provided for execution by a processor of a computing device, wherein the application program include instructions for broadcasting a live stream, wherein the live stream is receivable by a plurality of terminal devices via a communication network; receiving an indication of one or more tokens from a user of a terminal device during the broadcast of the live stream; if an amount of tokens received from the terminal device is greater than or equal to a reward parameter, establishing a control connection between the computing device and the terminal device; and instructing, through the control connection, an electronic device to perform one or more actions, wherein the electronic device is an adult toy connected with the terminal device.

The application program further includes instructions for displaying a control panel on a screen of the computing device. The control panel includes status information of the computing device and the plurality of terminal devices, and control keys for receiving control inputs. The status information includes one or more of waiting status of the computing device when the computing device is waiting for a tip, and controlling status of one or more terminal devices when establishing control connections. The control keys include operative control buttons corresponding to different levels of action by the electronic device, different control patterns, and different time, durations.

In the light of the foregoing, these and other objects are accomplished in accordance of the principles of the present application, wherein the novelty of the present application will become apparent from the following detailed description and appended claims.

### BRIEF DESCRIPTION OF DRAWINGS

The above and other objects and advantages of the present application will be apparent upon consideration of the following detailed description, taken in conjunction with the accompanying drawings, in which like reference characters refer to like parts throughout, and in which:

FIG. 1 is a schematic illustration of an application scenario of the interactive online entertainment system according to embodiments of the application;

FIG. 2 is a block diagram of the interactive online entertainment system according to embodiments of the application;

FIG. 3 is a flowchart of an interactive live streaming session according to embodiments of the present application;

FIG. 4 is a signal diagram of controlling the viewer's toy in a live streaming session according to the flowchart as shown in FIG. 3;

FIG. 5 is a signal diagram between entities of the interactive online entertainment system according to an embodiment of the present application;

FIG. 6 is an exemplary flowchart of operations from a host's side; and

FIG. 7 is an exemplary flowchart of operations from a viewer's side.

The disclosure will next be described in connection with certain exemplary embodiments. However, it should be clear to those skilled in the art that various modifications, additions, and subtractions can be made without departing from the spirit or scope of the appending claims.

### DETAILED DESCRIPTION

The present application pertains to a communication system and method that enable controlling of electronic devices over distances. In particular, the present application relates to actuating adult toys over distances in a live streaming session. For purposes of clarity, and not by way of limitation, illustrative views of the disclosed system and method are described with references to the above-identified figures. Various modifications obvious to one skilled in the art are deemed to be within the spirit and scope of the present application.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include input/output (I/O) components as well as associated processor, application, and/or application programming interface (API) components.

It is to be appreciated that determinations or inferences referenced throughout the application can be practiced through the use of artificial intelligence techniques. In this regard, some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Discussions herein utilizing terms such as, for example, “processing,” “computing,” “calculating,” “determining,” “establishing,” “identifying,” “analyzing,” “checking,” or the like, may refer to operations(s) and/or process(es) of a computer, a computing platform, a computing system, or other electronic computing device, that manipulate and/or transfer data represented as physical (e.g., electronic) quantities within the computer's registers and/or memories into other data similarly represented as physical quantities within the computer's registers and/or memories or other information storage medium that may store instructions to perform operations and/or processes.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion.

Additionally, the articles “a” and “an” as used in this application and the appended claims should generally be construed to mean “one or more” or “at least one” unless specified otherwise or clear from context to be directed to a singular form. Similarly, the terms “plurality” and “a plurality” as used herein includes, for example, “multiple” or “two or more.” For example, “a plurality of items” includes two or more items.

As used herein, the terms “user,” “users,” “end user,” “end users,” “audience,” “client,” “clients,” “customer,” and “customers” are interchangeable unless the context clearly suggests otherwise. Similarly, as used herein, the terms “host,” “hosts,” “performer,” “performers,” are used interchangeably unless the context clearly suggests otherwise. The terms “web browser extension,” “browser extension,” and “website” are used interchangeably unless the context clearly suggests otherwise. Furthermore, the foregoing terms “web browser extension,” “browser extension,” and “website” may be collectively referred to as “application,” “software,” or “software application.”

Some embodiments may be used in conjunction with various devices and systems. For example, a computing device or computer may be a server, a gateway device or a terminal device, such as a personal computer (PC), a desktop computer, a mobile computer, a laptop computer, a tablet computer, a server computer, a handheld device, a personal digital assistant (PDA), a wireless communication device, a smart cellular phone, a non-portable device, a wireless access point (AP), a wired or wireless router, a wired or wireless modem.

For another example, a communication network may be a wired or wireless network, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN), or networks operating in accordance with existing and/or future versions and/or derivatives of the long term evolution (LTE) network, or a fifth generation (5G) New Radio (NR) communication network.

Besides the computing devices as mentioned above by examples, an electronic device may be a device that is designed to perform certain functions. The electronic device may incorporate a global positioning system (GPS) receiver or transceiver or chip, a radio frequency identification (RFID) element or chip, a multiple input multiple output (MIMO) transceiver or device, a single input multiple output (SIMO) transceiver or device, or a multiple input single output (MISO) transceiver or device. The electronic device may have one or more internal antennas and/or external antennas, or the like. Particularly, certain electronic devices whose main purpose is to provide sexual stimulation, entertainment and/or therapy for adult users are collectively referred to herein as “adult toys” or “toys.” Various kinds of adult toys are well known in the art and are not described in details herein.

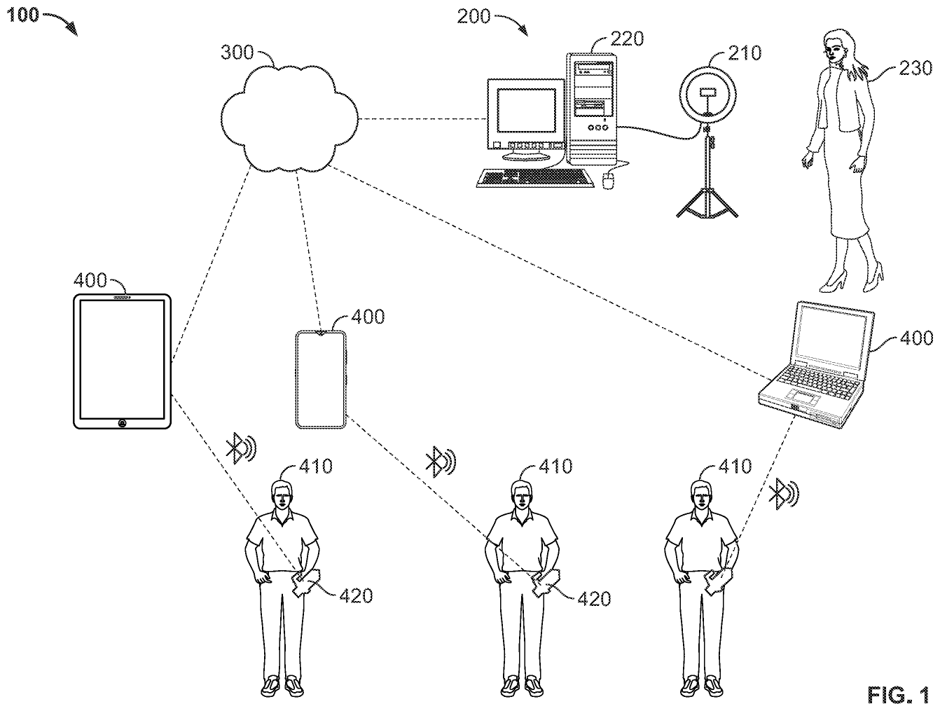

FIG. 1 is a schematic illustration of an application scenario of an interactive online entertainment system 100 in accordance with some embodiments of the present application. The system 100 includes equipment such as a live streaming studio 200. The live streaming studio 200 may include some or all of various studio equipment 210 (such as props, lighting equipment, speakers, microphones, cameras, audio/video players, etc.) capable of generating a live stream , and a computing device 220 having application programs for broadcasting the stream in real time or near real time (i.e. live streaming) through a communication network 300 (e.g. Internet, satellite, cable, etc.). Usually but not necessarily, a live streaming service is provided by a software platform or a website (such as Facebook Live, Bilibili, Youtube Live, etc. or a proprietary program provided by the inventor of the present application). A user of such a platform can set up a live streaming session and be a host 230. The host 230 usually announces the session through the platform. For example, the platform associates a quick response (QR) code or a Uniform Resource Locator (URL) with the session, and publish the QR code or the URL on a webpage. Other users of the platform can view the session on their computing devices by scanning the QR code or directing their web browsers to the URL. During a live streaming session hosted by the host 230, a viewer 410 may use a computing device or a terminal device (collectively referred to as a user device 400, which is connected to the communication network 300) to view the performance or presentation of the host 230 on the user device 400. According to the embodiments of the present application, during the live streaming session, the viewers are enabled to interact with the host 230 via a two-way communication such as live chatrooms or on-screen messages. A message sent by the viewer 410 to the host 230 may be displayed on a screen of the host's computing device 220. The message may or may not be visible to other viewers of the session, depending on privacy settings of the session. Similarly, a message sent by the host 230 to the viewer 410 may be displayed on the user device 400.

The user device 400 according to the embodiments of the present application also provides communication connectivity to an electronic device 420 via a WiFi network or a short-range radio link such as Bluetooth™. The electronic device 420 may be an adult toy as defined above, and the viewer 410 may operate or control the toy 420 by hands or via the user device 400.

As will be discussed in the details below, the interactive inline entertainment system 100 as provided by the embodiments of the present application enables the host 230 to control the viewer's toy 420 during a live streaming session, so as to provide entertainment to the viewer 410.

It is to be understood that the existing live streaming technology enables a larger number of viewers to view a live streaming session, and to interact with the host 230 simultaneously, and the viewer 410 is a representation of such viewers.

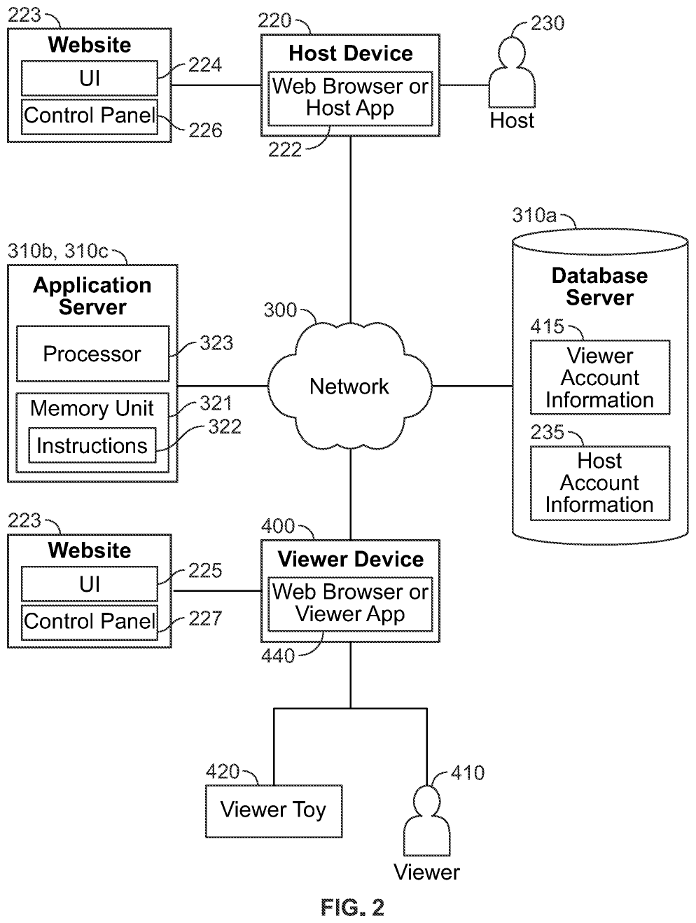

FIG. 2 is a technical block diagram of the interactive online entertainment system 100 in accordance with embodiments of the present application.

In the system 100, for providing a live stream, the host 230 uses studio equipment 210 (not shown in FIG. 2) and a computing device 220 (also referred to as host device 220). The computing device 220 includes a variety of hardware components, software modules and input/output (I/O) interfaces. For example, the computing device 220 may include one or more processors, controllers, memory units, storage units, display units, input circuits, output circuits, wired or wireless communication transceivers, operating systems, application programs, or the like. The studio equipment 210 may be connected to one or more of the I/O interfaces of the computing device 220, to allow audio and video signals be inputted to the computing device 220. When broadcasting a live streaming session, the host 230 launches a web browser or an application program 222 installed in the computing device 220, from which the host 230 can access a website 223 of the live streaming platform to set up the live streaming session (e.g. date, time, duration, restriction, etc.). A session link URL or a QR code is generated for the live streaming session.

A viewer 410 launches a web browser or an application program 440 on the user device 400 (also referred to as viewer device 400). The application program 440 connects the user device 400 to the website 223. The session link URL or the QR code of the live stream session is displayed on a screen of the user device 400. The viewer 410 can view the live streaming on the user device 400 by clicking the session link URL or scanning the QR code.

It should be understood that the website 223 may simultaneously provide URLs or QR codes for multiple live streaming sessions hosted by different hosts, and viewers may select a host from multiple hosts to enter into a live stream session of the host via the website 223.

In addition to viewing the live streaming, the host 230 may engage in an online chat with the viewer 410 via a host's user interface (UI) 224 of the application program 222 and the viewer 410 can chat with the host 230 via a viewer's UI 225 of the application program 440. The UI 225 allows the viewer 410 to enter a message to the host 230 and/or send a tip (reward) in an amount of virtual tokens to the host 230. It should be understood that, during the live streaming, the host 230 may simultaneously engage in live conversations with multiple viewers and accept tips from multiple viewers.

The user device 400 may be one of a wide range of devices such as a personal computer (PC), a desktop computer, a mobile computer, a laptop computer, a tablet computer, a handheld device, a personal digital assistant (PDA), a smart cellular phone, or the like. There is no limitation on what user device may be used to view the live streaming.

The live streaming platform allows the host 230 to set up a host account 235 and allows the viewer 410 to set up a viewer account 415, respectively. In creating or updating the viewer account 415, the viewer 410 can create/update his or her username and password and input age (for verifying eligibility) and payment information (such as bank account, credit card number, or online payment account), plus other types of identification information associated with the viewer 410, if necessary. The website 223 verifies the information of the viewer 410 and grants a permission if the viewer 410 is verified as eligible and credible. Similarly, the host 230 can create/update the host account 235 by inputting/updating information such as the host's name, age, gender, location, and the like, and the information is verified.

There may be one or more servers that provide data storage and program execution for the live streaming. In embodiments of the present application, the servers may be connected to host's computing device 220 and the viewer's device 400 directly or via the communication network 300. For example, a database server 310a provides a database which stores information of the viewer account 415 and information of the host account 235. The viewer account 415 and the host account 235 may be updated in real-time with the live streaming. An application server 310b may be configured to handle broadcasting of the live streaming. Another application server 310c may be configured to provide live interaction between hosts and viewers, and to send/receive reward tokens. As an example, the application server 310b may include a memory unit 321 having instructions 322 stored thereon, and a processor 323, wherein the processor 323 is configured to execute the instructions 322. It should be noted that some or all of the program instructions for the interactive online entertainment system 100 may be executed by the host's computing device 220 or by any of the servers 310a, 310b and 310c, and these computing devices may be separately deployed or integrated together.

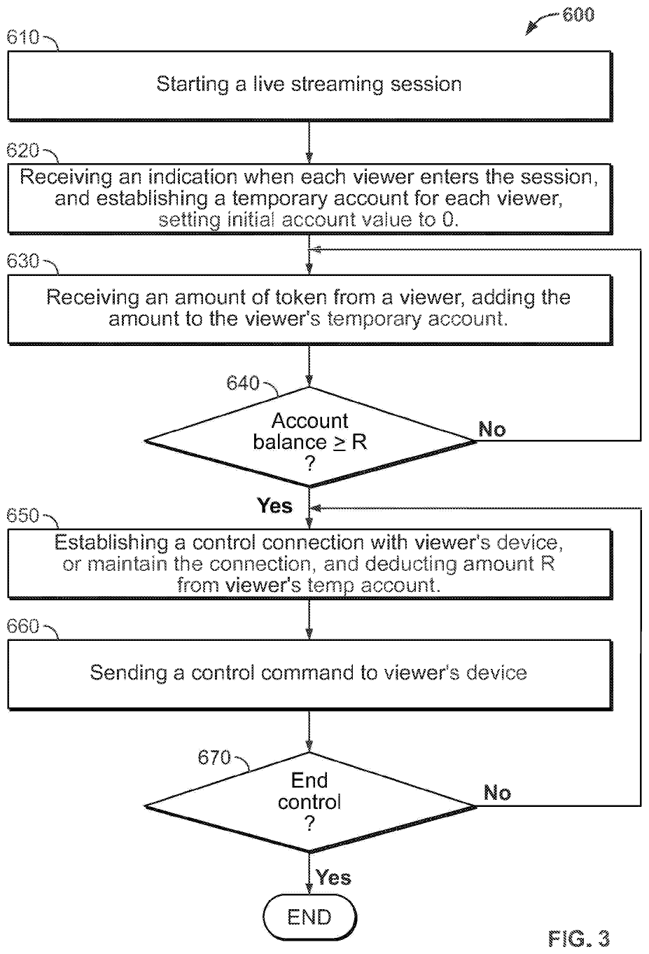

FIG. 3 is a flowchart of a live streaming session 600 according to an embodiment of the present application.

At block 610, the live streaming session is started by a host 230 and is broadcast to multiple viewers by a live streaming website 223 via a communication network 300. During or before the broadcast, a URL or a QR code associated with the session is displayed on viewers' devices, enabling the viewers to enter the session and view the host 230. Preferably, each viewer is pre-registered with the website 223, so an account of the viewer is properly set up as described above. Similarly, the host 230 also sets up a host account 235, enabling the host 230 to receive rewards or tips from the viewers.

The website 223 may simultaneously provide information of multiple live streaming sessions hosted by different hosts, and viewers may select a host from multiple hosts to enter into a live stream session of the host via the website 223. Depending on settings, a live streaming session can be a private (i.e., one-on-one) session, a group session (i.e., limited number of viewers and one host), or a public session (i.e., unlimited number of viewers).

During the live streaming, the website 223 provides the host's UI 224 and the viewer's UI 225 that allow the viewer 410 and the host 230 to send and receive messages in a textual and/or audio format, so as to have a live conversation with each other (e.g., in an online chatroom). The messages may or may not be visible to or playable by other viewers of the session, depending on privacy settings of the session.

At block 620, during the live streaming session, the website 223 receives an indication when each viewer enters the session. For example, a viewer 410 enters the session by directing a web browser or application program 440 running on user device 400 to the URL or scanning the QR code associated with the session. The website 223 establishes a temporary account for each viewer. An initial value of the temporary account may be set to zero, or any other value.

At block 630, the website 223 receives an indication that the viewer 410 has sent an amount of virtual coins (aka tokens) as a reward to the host 230. The website 223 adds the amount of tokens to the viewer's temporary account. Meanwhile, an amount of currency corresponding to the amount of token is deducted from the viewer's account 415. The viewer 410 can send tokens multiple times, and the amount of tokens in the temporary account accumulates.

During the live streaming session, the website 223 allows the host 230 to accept tokens from some or all of the viewers as tips or rewards. The tokens can be converted into a real currency and credited to the host's account 235. The host 230 can define and edit reward parameters that are applied during the live streaming session, and display the reward parameters with the live streaming. The website 223 may allow the host 230 to designate specific tip amounts and/or ranges of tip amounts, and define actions correlating to each of the tip amounts and/or ranges. For example, the host 230 may require the tips in increments of five tokens, where each token corresponds to an amount of real currency, such as one dollar.

At block 640, the website 223 determines whether the amount of token currently in the viewer's temporary account equals or exceeds a reward parameter R.
a) If the answer is no, the website 223 continues to wait for indication of more reward tokens from the viewer 420.
b) If the answer is yes, at block 650, the website 223 establishes a control connection between the host's computing device 220 and the viewer's user device 400. Meanwhile, an amount of tokens equivalent to the reward parameter R is deducted from viewer's temporary account. The control connection between the computing device 220 and the user device 400 may be established for a pre-determined time duration corresponding to the reward parameter R. If more tokens are received after the deduction, the duration of the control connection may be extended. Alternatively, if the control connection has been established previously, and the viewer's temporary account still has unused tokens or new tokens are added after the control connection is established, the control connection may be extended by applying the remaining tokens.

In some embodiments, the website 223 is configured to, on behalf of the host 230, send a message to the viewer 410 asking if the viewer 410 accepts control of the viewer's toy 420 by the host 230. If the viewer 410 responds with an indication agreeing to the control of the viewer's toy 420, the host 230 gains the control of the viewer's toy 420 either directly (if the toy 420 is Wi-Fi enabled) or via the viewer's user device 400 to which the toy 420 is connected via a short-range radio link such as Bluetooth™.

In some embodiments, establishing the control connection between the computing device 220 and the user device 400 may include the website 223 sending a message to the user device 400. The message requests the viewer 410 to indicate whether to grant a permission to control the viewer's toy 420 through the user device 400. The user device 400 sends a reply to the website 223 granting the permission. After receiving the permission, the control connection is established. Establishing the control connection means the computing device 220 is enabled to control the toy 420. The control connection may last for the entire live streaming session, or for a pre-determined time duration, which is shorter than the length of the session.

In embodiments of the present application, the actions correlating to each of the tip amounts and/or ranges may include performances of the host 230 (such as singing and/or dancing by the host 230) for a pre-defined time duration, or controlling the tipping viewer's toy 420 remotely (such as over the network 300) to perform a function or functions of the toy 420 for a pre-defined time duration.

At block 660, using the computing device 220, the host 230 sends an instruction to the viewer's toy 420 through the control connection, instructing the toy 420 to perform one or more actions corresponding to the reward parameter.

The actions that may be performed by the toy 420 include, and not limited to, one or more of vibration, rotation, swinging, inhalation, temperature variation, expansion, suction, contraction, bending, and reciprocation. Under the control of the host 230, the viewer's toy 420 performs an action as if the toy 420 is controlled by the viewer 410. Each action by the toy 420 may be further defined by parameters such as time duration, intensity, interval, etc. As configured by the host 230, a certain amount of token correlates to a certain action and certain parameters (such as kind of action, duration, intensity, etc.). For example, the host 230 can set up parameters such that a tip amount between 1 to 10 tokens may cause the viewer's toy 420 to vibrate at a low speed for 10 seconds, and a tip amount between 11 to 20 tokens may cause the viewer's toy 420 to thrust at a high speed for 10 seconds. Alternatively, a tip amount of 30 tokens may cause the viewer's toy 420 to rotate at a high speed for 15 seconds. Also, the host 230 may control the toy 420 based on viewer's real-time feedback.

If the control connection is set for a limited time duration, at block 670, a decision may be made whether to terminate the control connection when the time duration expires, so the computing device 220 of the host 230 no longer controls the toy 420. A termination may be made if the remaining token amount in the viewer's temporary account is less than the reward parameter, if the viewer 410 terminates the connection from the user device 400, if the viewer 410 exits the live streaming session, or when the live streaming session ends. The connection may be maintained or extended if the viewer's temporary account has unused tokens and the viewer 410 agrees to apply the unused tokens. The length of the extension may be proportional to the number of tokens applied.

At the end of the live streaming session, the host 230 may collect all tokens in all temporary accounts of the viewers, and receive a financial reward that is equivalent or proportional to the amount of all collected tokens.

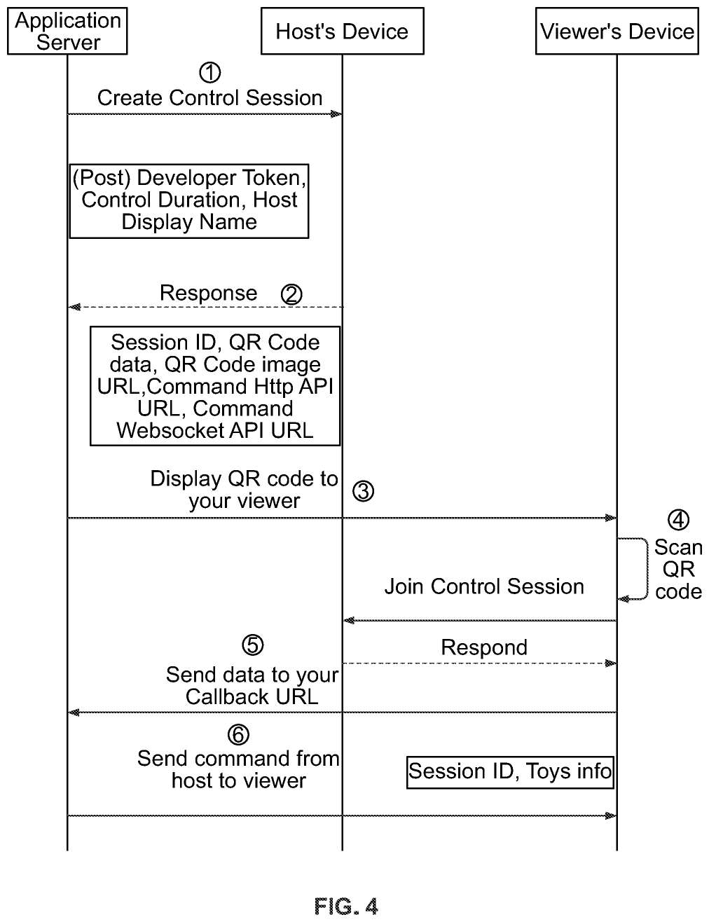

FIG. 4 is a signal diagram of controlling viewer's toy in a live streaming session in accordance with the flowchart of FIG. 3.

Besides website-based live streaming as described above, other types of application programs may also be used. For example, other downloadable and/or a non-downloadable software application (e.g., a plug-in application, an application extension, a mobile application) may be used in lieu of or in addition to the website 223, and operations or functions of these software applications are similar to the website 223, with features designed to implement the present invention.

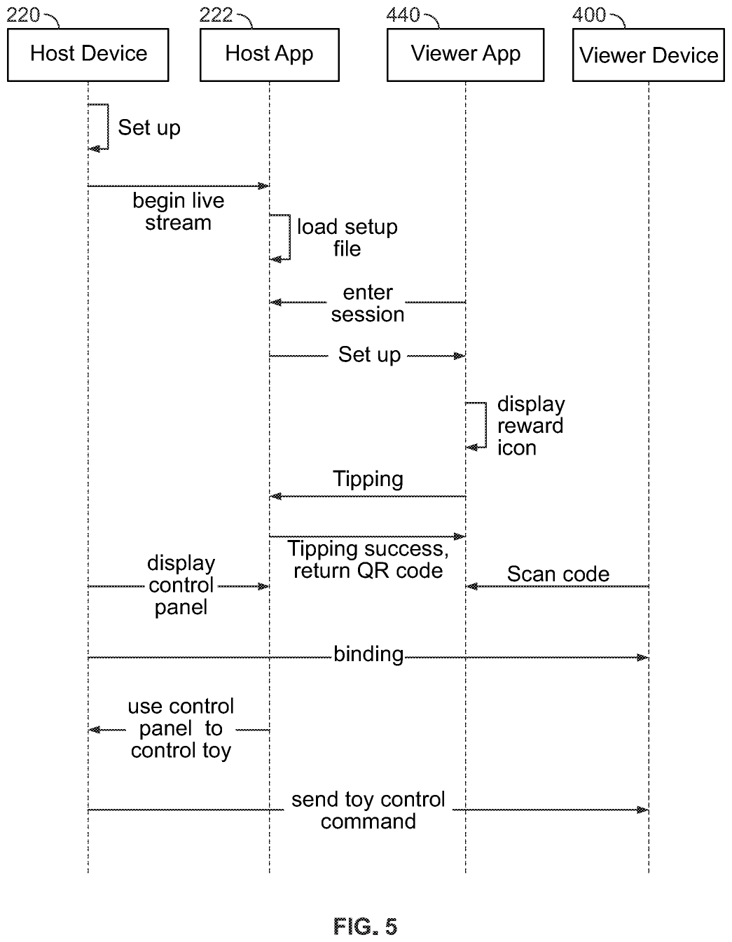

FIG. 5 is a signal diagram of the interactive online entertainment system 100 according to some embodiments of the present application. According to these embodiments, a host 230 has an application program or a plug-in (collectively referred to as host's app 222) installed in the host's computing device 220, and a viewer 410 has an application or a plug-in (collectively referred to as viewer's app 440) installed in the viewer's user device 400. In order to establish a control connection between the host device 220 and the viewer device 400 (in response to host 230 providing a code and the viewer 410 scanning or entering the code), steps as shown in FIG. 5 are performed.

The host 230 launches the host's app 222, which allows the host 230 to set up various reward parameters for a live streaming session. The host's app 222 starts the live streaming session. By uploading a configuration file, for example, the host 230 is able to configure the settings of the live streaming session, such as privacy setting, time setting, reward parameter setting, etc., and take control of the live streaming session.

A viewer 410 launches the viewer's app 440 on the user device 400 and enters the live streaming session by scanning the code. The live streaming is displayed on the viewer's device 400. By entering the live streaming session, the viewer 410 is able to tip the host 230 and invite the host 230 to take control. “Taking control” means the host is permitted to establish a “controlled by the host” connection with the viewer's toy 420. In some embodiments, the “controlled by the host” connection is established by dialogs between the host's app 222 and the viewer's app 440 via the application server 320 of the interactive online entertainment system 100. The user device 400 “talks” to the toy 420 through a short-range wireless communication link.

The viewer's app 440 is configured to display a reward icon on the user device 400. If the viewer 410 wants to tip the host 230, the viewer 410 may click the icon. Reward parameters set up by the host 230 may be displayed as a drop-down menu on the user device 400. The viewer 410 can send a tip by selecting an option on the drop-down menu. If the tip is successfully sent, the host's app 222 returns a QR code, and the QR code is displayed on the viewer's screen. The viewer 410 scans the QR code, allowing the host's device 220 to bind with the viewer's device 400. Subsequently, the host's app 222 is enabled to take control of the viewer's toy 420 via the viewer's device 400.

A control panel 226 is displayed on host's device 220 (see FIG. 2). The host's app 222 senses a control command input by the host 230 via the control panel 226, and sends the control command to the viewer's device 400.

The host's app 222 is configured to scan for tips during live streaming sessions and receive tips from viewers of the session. The host's app 222 can determine whether received tips from a viewer 410 falls within one of the tip parameters or whether the tip is equal to or greater than a specified tip amount defined by the host 230. For example, if one of the tip parameters is 1 to 10 tokens to vibrate the viewer's toy 420 at a low speed for 10 seconds, and the viewer 410 tips 4 tokens, then the tip amount is valid. If, however, one of the tip parameters is 11 to 20 tokens to vibrate the viewer's toy 420 at a high speed for 10 seconds, the tip amount is not enough and the viewer 410 may be prompted to adjust (i.e., increase) the tip amount, in some embodiments. Alternatively, the viewer's toy 420 can still react as long as the tip falls in one of the tip parameters. It is contemplated that the viewer 410 can purchase credits, points, or other types of virtual currency such as tokens that can be credited to his or her account 235 and use the virtual currency to tip the host 230.

If the host's app 222 determines that the received tip is less than the reward parameter, it may be configured to send a notification to the viewer's device 400 alerting the viewer 410 that the tip amount is insufficient and the viewer's toy 420 won't be actuated.

The viewer 410 can enter a tip amount during the live streaming session in more than one manner, for example, by typing in the amount of tip within a conversation thread, or by selecting a tip amount from a drop-down menu. The viewer 410 can tip multiple times during the live streaming session to accumulate the tip amount. Alternatively, one viewer can transfer his/her tip amount to another viewer, i.e. tipping the host on behalf of another viewer.

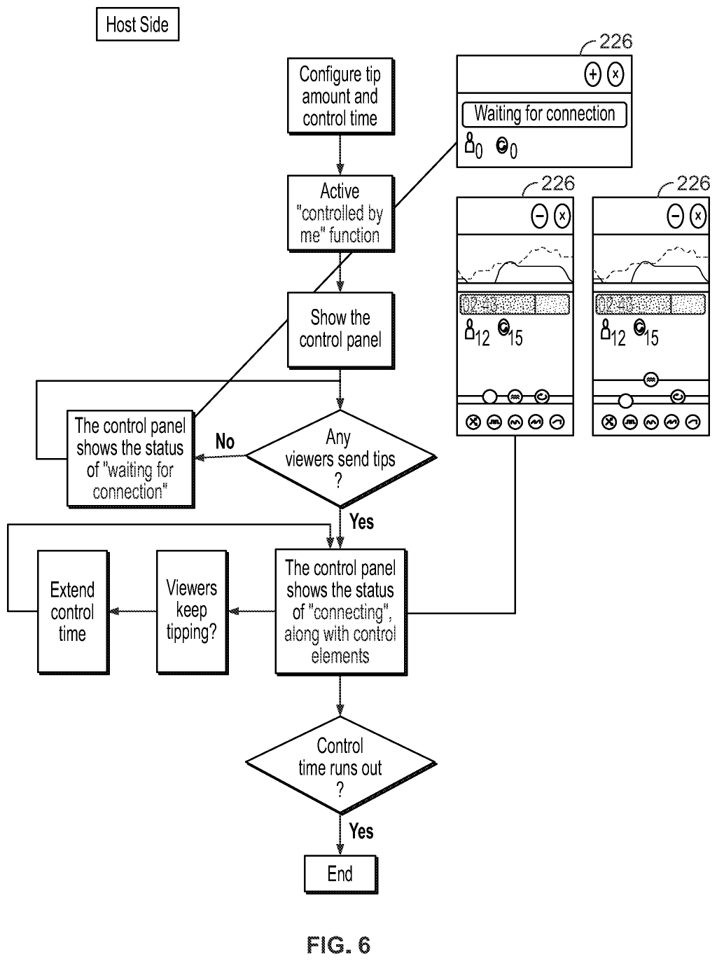

FIG. 6 is an exemplary flowchart of operations from a host's side. The host 230, by using the host's app 222, configures tip amount(s) and a control time length for a live streaming session. Also, in accordance with the above description, the host 230 activates a “controlled by me” function by using the host's app 222. As a result, a control panel 226 is displayed on host's device 220. During the live streaming, the host's app 222 scans the viewers of the session to see if any viewer has send a tip. If no viewer is sending the tip, the control panel 226 displays the status of “waiting for connection.” If a tip is received from a tipping viewer, the control panel 226 shows the status of “connecting”, along with control elements.

After a connection is established with the tipping viewer, the host 230 can select an action from the actions icons displayed in the control panel 226 and send a command to the viewer's toy 420 in a manner as described above. The toy 420 performs the action for a pre-defined controlling period. Controlling time remaining is displayed on the control panel 226.

During the controlling period, the host's app 222 continues to scan (1) for any tips from other viewers, and establish a control connection for each tipping viewer; (2) for continued tipping from the connected viewers. The control time may be extended if there is more tipping from the connected viewers. When the control time runs out, the control connection ends.

Optionally, the control panel 226 includes status information of the host's device 220 and the plurality of terminal devices, and control keys for receiving control inputs from the host 230. The status information may include one or more of waiting status of the computing device 220 when the computing device 220 is waiting for a tip, and controlling status of one or more terminal devices when establishing control connections. The control keys include operative control buttons corresponding to different levels of action by the electronic device 420, different control patterns, and different time durations.

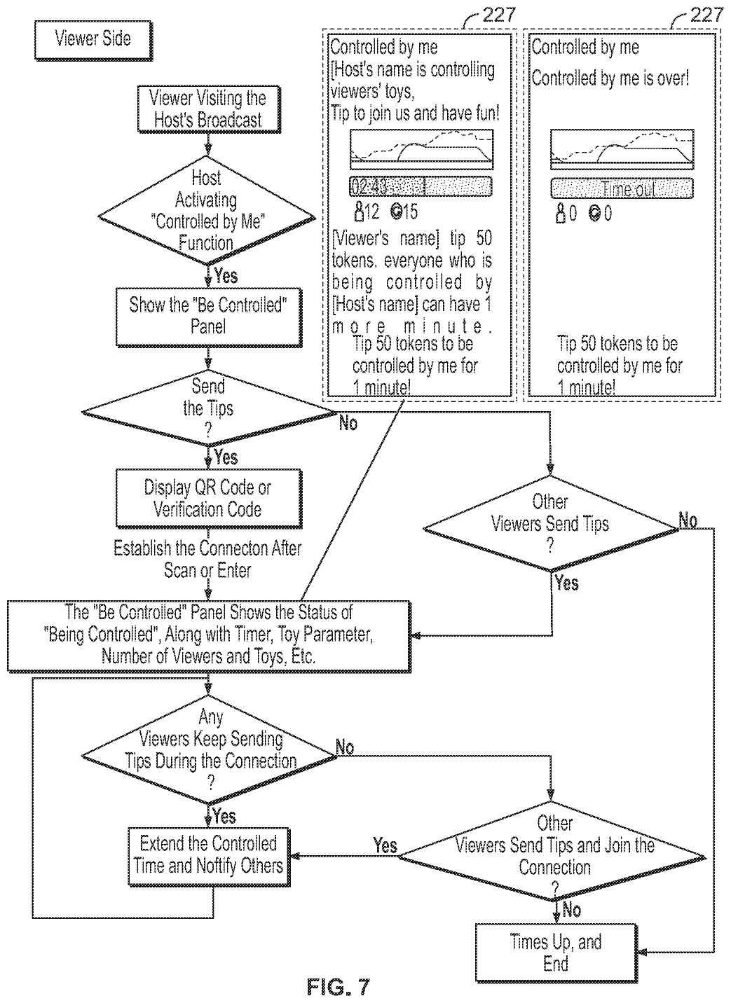

FIG. 7 is an exemplary flowchart of operations from a viewer's side. The viewer 410 launches the viewer's app 440 on a user device 400 to visit the live streaming broadcast of the host 230. The live streaming is displayed on the user device 400. The host's app 440 activates a “controlled by me” function after the viewer 410 grants a permission. A “be controlled” panel 227 is displayed on the user device 400. The viewer 410 can now decide whether to send a tip to the host 230 using the “be controlled” panel 227. Further, the viewer 420 can refer to information displayed on the user device 400 to determine the amount of tokens to be sent to the host 230.

If the viewer 410 decides to send a tip, after receiving the tip, the host's app 222 causes a QR code or a verification code to be displayed on the user device 400. The viewer 410 gives the permission of being controlled by scanning or entering the code. The “be controlled” panel 227 on the user device 400 shows the status of “being controlled”, along with other information, such as a timer, parameters of the toy to be controlled, numbers of viewers currently tipping, number of toys currently active, etc.

If the viewer determines not to send a tip, the “controlled panel” 227 does not show the status of “being controlled”, but number of viewers currently tipping and number of toys currently active may still updated and displayed.

If the viewer 410 is “being controlled”, the user device 400 will receive commands from the host's device 220, and the viewer's toy 420 is actuated by the host 230 via a connection between the user device 400 and the toy 420, such as a Bluetooth™ connection.

In alternative embodiments, the host's control to the viewers' toys can be in a one-to-many manner. If multiples viewers tip the host, and a total amount of tokens from the viewers is greater than or equal to a reward parameter set by the host, all the tipping viewers may have their toys be controlled by the host for a pre-defined time duration. During the controlling period, the host's app scans for more tips from the viewers. If more tips are received form any of the viewers, or if there is new tipping viewers join, the controlling period may be extended for all viewers, and all viewers are notified of the extension. If no more tips is received, the controlling connection ends at the expiration of the controlling period for all the viewers.

In other alternative embodiments, the host's app 222 is configured to set up a time window for collecting tips from viewers. The total amount of tips, or individual amount of tips from each tipping viewer, accumulates in the time window. When time window closes, the host's app 222 determines if the total tip amount, or each individual tip amount, reaches a preset threshold. If the tip amount reaches the threshold, the host's app 222 establishes control connections to the qualified tipping viewers.

The instant application has been shown and described in what is considered to be the most practical and preferred embodiments. It is recognized, however, that departures may be made within the scope of the application and that obvious modifications will occur to a person skilled in the art. With respect to the above description then, it is to be realized that the optimum dimensional relationships for the parts of the application, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present application.

Therefore, the foregoing is considered as illustrative only of the principles of the application. Further, since numerous modifications and changes will readily occur to those skilled in the art, it is not desired to limit the application to the exact construction and operation shown and described, and accordingly, all suitable modifications and equivalents may be resorted to, falling within the scope of the application.

1. A method for providing online interactive entertainment for adults, the method comprising:
broadcasting, by a host device operated by a host, a live stream hosted by the host, wherein the live stream is receivable by a plurality of viewer devices via a communication network;
receiving, by the host device, an indication of one or more tokens from a user of a first viewer device from among the plurality of viewer devices during the broadcast of the live stream, wherein the live stream and a user interface are displayed on the first viewer device;
in response to an amount of tokens received from the first viewer device being greater than or equal to a reward parameter, establishing, by the host device, a first control connection between the host device and the first viewer device;
displaying, on the host device, a control panel including status information and at least one control key, the status information including at least one of (i) information on viewer devices from among the plurality of viewer devices with which the first control connection is established, and (ii) information on at least one of viewer accessories respectively operably connected to the viewer devices, and the status information being indicated on the control panel in real time; and
instructing, by the host device through the first control connection, a first viewer accessory to perform an action with an intensity, a duration, or an action pattern adjustable in real time according to inputs on the control key,
wherein the viewer accessory is an adult toy connected with the first viewer device via a short-range radio communication link, and both the first viewer accessory and the first viewer device belong to a same user.

2. The method of claim 1, further comprising:
receiving, by the host device, at least one of text message and audio message from at least one of the plurality of viewer devices during the broadcast of the live stream.

3. The method of claim 1, further comprising:
after receiving the indication of one or more tokens from the first viewer device during the broadcast of the live stream, sending, by the host device, a response to the first viewer device indicating whether an amount of the one or more tokens received from the first viewer device is greater than or equal to the reward parameter.

4. The method of claim 1, wherein the establishing the first control connection comprises:
in response to an amount of tokens received from the first viewer device during a time window being greater than or equal to the reward parameter, establishing the first control connection between the host device and the first viewer device for a preset duration of time.

5. The method of claim 4, further comprising:
extending the first control connection for an extended duration of time when additional tokens are received after establishing the first control connection;
wherein the extended duration of time is proportional to an amount of the additional tokens received after establishing the first control connection.

6. The method of claim 1, further comprising:
receiving, by the host device, an indication of one or more tokens from a user of a second viewer device from among the plurality of viewer devices during the broadcast of the live stream;
in response to an amount of tokens received from the second viewer device being greater than or equal to the reward parameter, establishing, by the host device, a second control connection between the host device and the second viewer device; and
instructing, by the host device through the second control connection, a second viewer accessory to perform one or more actions, wherein the second viewer accessory is an adult toy connected with the second viewer device.

7. The method of claim 1, wherein the establishing the first control connection comprises:
sending, by the host device, a message to the first viewer device, wherein the message requests the first viewer device to indicate whether to grant a permission to control the first viewer accessory by the host device;
receiving, by the host device, a reply from the first viewer device; and
establishing the first control connection enabling the host device to control the first viewer accessory in response to the reply from the first viewer device granting the permission.

8. The method of claim 1, wherein the instructing the first viewer accessory to perform the action comprises:
sending, by the host device, a command to the first viewer device through the first control connection, wherein the command instructs the first viewer device to control the first viewer accessory, and the first viewer accessory performs one or more actions according to the command.

9. The method of claim 1, wherein the action comprises at least one of:
vibration,
rotation,
swinging,
inhalation,
temperature variation,
expansion,
suction,
contraction,
bending, and
reciprocation.

10. The method of claim 1, wherein the reward parameter comprises one or more ranges of tip amounts, and one control duration of a control to the first viewer accessory or one action performed by the first viewer accessory correlates to each of the one or more ranges.

11. An online entertainment system, comprising:
a host device operated by a host;
a viewer device connected with the host device via a communication network; and
an adult toy connected with the viewer device via a short-range radio communication link, wherein both the adult toy and the viewer device belong to a same user;
wherein the host device comprises a processor, a memory for storing an application program, a display unit, and a transceiver for communicating with the viewer device;
wherein by executing the application program, the host device is configured to:
broadcast an audio and video live stream hosted by the host to a plurality of viewer devices via the communication network;
receive an indication of one or more tokens from the user of the viewer device during the broadcast of the live stream;
in response to an amount of tokens received from the viewer device being greater than or equal to a reward parameter, establish a control connection between the host device and the viewer device;
display a control panel on the display unit, the control panel including status information and at least one control key, the status information including at least one of (i) information on viewer devices from among the plurality of viewer devices with which the control connection is established, and (ii) information on at least one of adult toys respectively operably connected to the viewer devices, and the status information being indicated on the control panel in real time; and
instruct, through the control connection, the adult toy to perform an action with an intensity, a duration, or an action pattern adjustable in real time according to inputs on the control key.

12. The system of claim 11, wherein by executing the application program, the host device is further configured to:
receive at least one of text message and audio message from at least one of the plurality of viewer devices during the broadcast of the live stream.

13. The system of claim 11, wherein by executing the application program, the host device is further configured to:
after receiving the indication of one or more tokens from the viewer device during the broadcast of the live stream, send a response to the viewer device indicating whether an amount of the one or more tokens received from the viewer device is greater than or equal to the reward parameter.

14. The system of claim 11, wherein in establishing the control connection, the host device is configured to:
in response to an amount of tokens received from the viewer device during a time window being greater than or equal to the reward parameter, establish the control connection between the host device and the viewer device for a preset duration of time.

15. The system of claim 14, wherein the control connection is extended for an extended duration of time when additional tokens are received after establishing the control connection; and
wherein the extended duration of time is proportional to an amount of the additional tokens received after establishing the control connection.

16. The system of claim 11, wherein in establishing the control connection, the host device is configured to:
send a message to the viewer device, wherein the message requests the viewer device to indicate whether to grant a permission to control the adult toy by the host device;
receive a reply from the device; and
establish the control connection enabling the host device to control the adult toy in response to the reply from the viewer device granting the permission.

17. The system of claim 11, wherein in instructing the adult toy to perform the action, the host device is configured to:
send a command to the viewer device through the control connection, wherein the command instructs the viewer device to control the adult toy, and the adult toy performs one or more actions according to the command.

18. A non-transitory computer-readable medium storing program codes thereon for execution by a processor of a host device operated by a host, wherein the program codes comprise instructions for:
broadcasting an audio and video live stream hosted by the host, wherein the live stream is receivable by a plurality of viewer devices via a communication network;
receiving an indication of one or more tokens from a user of a viewer device from among the plurality of viewer devices during the broadcast of the live stream, wherein the live stream and a user interface are displayed on the viewer device;
in response to an amount of tokens received from the viewer device being greater than or equal to a reward parameter, establishing a control connection between the host device and the viewer device;
displaying a control panel on the host device, the control panel including status information and at least one control key, the status information including at least one of (i) information on viewer devices from among the plurality of viewer devices with which the control connection is established, and (ii) information on at least one of adult toys respectively operably connected to the viewer devices, and the status information being indicated on the control panel in real time; and
instructing, through the control connection, an adult toy to perform an action with an intensity, a duration, or an action pattern adjustable in real time according to inputs on the control key,
wherein the adult toy is connected with the viewer device via a short-range radio communication link, and both the adult toy and the viewer device belong to a same user.

19. The non-transitory computer-readable medium of claim 18, wherein the status information further includes information on the host device; and
wherein the status information on the host device comprises information on a waiting status of the host device when the host device is waiting for a tip.

20. The non-transitory computer-readable medium of claim 18, wherein the program codes further comprise instructions receiving an input from a user of the host device;
wherein the input comprises one or more preset reward parameters, the reward parameters comprising one or more ranges of tip amounts, and each range corresponding to an action by the adult toy and a time duration; and
wherein when the amount of tokens received from the viewer device falls into one of the ranges, the host device instructs the adult toy to perform an action for a time duration corresponding to the one of the ranges.
